(19) United States
(12) Patent Application Publication
(10) Pub. No.: US 2003/0163818 A1
(43) Pub. Date: Aug. 28, 2003

(54) Open documentary: a unique, new format for broadcasting video on the internet

(76) Inventors: Peter Armstrong, London (GB); William Ross, London (GB)

Correspondence Address: PETER ARMSTRONG, ONE WORLD INTERNATIONAL, 17TH FLOOR, 89 ALBERT EMBANKMENT, LONDON, SE1 7RT, GB

(21) Appl. No.: 10/083,519

(22) Filed: Feb. 26, 2002

(51) Int. Cl. H04N 5/445; G06F 3/00; G06F 13/00

(52) U.S. Cl. 725/61

(57) ABSTRACT

The Open Documentary is a unique, new format for broadcasting video on the internet, a collaborative, navigable, online format which can be watched like TV or explored like the web. An advance from simple webcasting, the Open documentary will enable people to upload video clips and create storyline sequences from fragments of their own and other people's video material. The Open Documentary system will combine and recombine the clips until they are knitted into the fabric of the site. As a result, stories will start to overlap, interlink and branch off from one another in a variety of new directions as each storyline becomes just one part of a diverse narrative tapestry. By providing an interactive forum for stories to unfold, the Open Documentary will evolve into a collaborative space, tackling a landscape of interlocking subjects in a manner far more powerful than any single filmmaker or organisation could manage.

### FIELD OF ENDEAVOUR AND RELATED ART

One World International has been developing its use of video on the internet in the belief that it represents the most powerful tool for maximising the public impact of our partners work in the fields of human rights and sustainable development. One World TV has been broadcasting 30 minute documentaries over the web for the last 12 months. The key to increased demand for video on the web is broadband. It is predicted that by 2004, broadband users will exceed 80 million worldwide and this rise will be driven by increased adoption of streaming multimedia content. However, despite the future convergence of TV and the internet, they will remain very distinct vehicles of communication and the most successful converged services will be cut from a wholly different cloth. Compelling new formats must be developed that are interactive, accessible and designed for broadband, not just re-packaged from TV.

One World is now moving beyond simple webcasting to deliver video content that is more appropriate to the internet and more effective in commnunicating for social change. We have developed the idea of the Open Documentary, a collaborative, navigable, online format which can be watched like TV or explored like the web.

### SUMMARY OF IDEA

A departure from traditional linear-form documentary, the Open Documentary will deconstruct stories into 30 second clips of raw footage—each fragment, a piece of evidence, a testimony, an opinion. These clips will be linked together in simple storyline sequences. At the end of each clip, a series of questions will be presented to the viewer. By choosing a path of enquiry, the viewer branches off to the next clip which answers that question and so on. The viewer can navigate through the clips, choosing which storylines to follow, engaging in an interactive exploration through a matrix of interwoven narratives.

The stories will inevitably provoke more questions than answers. The Open Documentary system will provide tools to enable viewers to upload their own string of clips, adding a different perspective, fresh evidence or new characters to develop existing storylines. As the fragments settle into the system they will be combined and recombined with other stories until they are knitted into the fabric of the site. As a result, stories will start to overlap, interlink and branch off from one another in a variety of new directions as each storyline becomes just one part of a diverse narrative tapestry. By providing an interactive forum for stories to unfold, One World TV will evolve into a collaborative, Open Documentary space, tackling a landscape of interlocking subjects in a manner far more powerful than any single filmmaker or organisation could manage.

### DETAILED DESCRIPTION

The open documentary device plays short clips of multimedia to an online audience. They are held in a back-end database but are presented within a matrix of storylines, so that the viewer is offered alternative paths forward to satisfy different lines of enquiry after each clip. Each storyline is the authored product of an individual, but the system into which they are set is such that the individual narratives have the possibility of intersecting. This offers the viewer a multi-layered network of clips joined by many pathways of alternative narrative links. To provide these links in an optimal manner the software matches clips according to data from their creator, story links input by others and keyword matching.

### DETAILED DESCRIPTION CONTINUED

Another unique feature in the open documentary space is the manner in which film clips can be put together. The programme gives the opportunity for any registered user to upload their own clips (text, audio, video or stills) and to do so in the context both of their own storyline and the intersection of the existing matrix of stories. Alternatively the system allows them to superimpose their own new storylines on existing clips. In this way a single clip or sequence of clips can have multiple interpretations as part of different narratives. This process is augmented by the facility to add further layers of meaning through the addition of subtitles and commentary text.

A rating system allows all viewers to score clips and stories, as a way of ensuring that the best quality is promoted to maximum visibility for subsequent users. This too is part of the power of community video-building, in contrast to traditional film or video editing by single individuals or small teams.

The implementation of the system is an object-oriented Perl application driven by a MySQL custom database. The system and the media assets can run on one or many web servers, with public access for viewing, uploading and story editing through any online browser.

1. What I claim as my invention is a collaborative, navigable, database driven format for broadcasting video on the internet, providing tools for people to upload video footage, images and text, engage in an interactive viewing experience, explore the database of video clips and create compound stories from new and existing video clips.
